(19) United States
(12) Patent Application Publication
(10) Pub. No.: US 2009/0313181 A1
(43) Pub. Date: Dec. 17, 2009

(54) SYSTEM AND METHOD FOR INTERNATIONAL PARTNER COLLABORATION

(75) Inventors: Mark Louis Beechner, Wappingers Falls, NY (US); Kerry Enright, Williston, VT (US); Frank Ting Liang, Poughkeepsie, NY (US); Barry C. McCormick, Hopewell Junction, NY (US); John Power, Trim (IE); Kenneth David Rocheleau, South Hero, VT (US); Ruey-Ming Yang, Wappingers Falls, NY (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 12/136,826

(22) Filed: Jun. 11, 2008

(51) Int. Cl. G06Q 10/00

(52) U.S. Cl. 705/400

(57) ABSTRACT

A system and associated method for gathering data necessary for exchanging a product between at least two partners. Each partner in said at least two partners resides in a different country. The method provides for gathering information regarding the product being exchanged and more specifically a delivery location, a returning date and returning location if the product is being returned to said sending partner, a single valuation for said product being exchanged, a lot number for said product, clean-room requirements for said receiving partners, a product history, and a genealogy of said product being exchanged. After collecting the information, the method formats said information according to the specific receiving partner's requirements. The method further determines the appropriate method of transmission according to each receiving partner's requirements. Finally, the method sends each receiving partner their specifically formatted version of the information regarding the product being exchanged.

### BACKGROUND OF THE INVENTION

The present invention relates generally to managing collaborative product production and more specifically to gathering information necessary to facilitate global collaboration.

Developers of “bleeding edge” technology face rapidly escalating complexity along with increased risk and production costs. In response, many developers collaborate through exchanging production builds between partners to compare results, ensure product correlation, and facilitate interoperability. As powerful as it is, this method of collaborative development through product exchange introduces a host of unanticipated challenges meeting import/export regulations, site exchange details, and product traceability.

### SUMMARY OF THE INVENTION

In view of the foregoing and other exemplary problems, drawbacks, and disadvantages of the conventional systems and methods, the present invention provides a method for gathering data necessary for exchanging a product between at least two partners, wherein one partner in said at least two partners is a sending partner, wherein each partner in said at least two partners which is not said sending partner is a receiving partner, wherein said sending partner and each receiving partner is a different partner, wherein each partner in said at least two partners resides in a different country, said method comprising:

gathering information regarding said product being exchanged, said information consisting of: a delivery location for each said receiving partner; a flag determining whether said product is returning to said sending partner; a returning date and returning location if said flag confirms said product is being returned to said sending partner; a single valuation for said product being exchanged, said single valuation being a function of an average cost for each partner of said at least two partners and a scenario number for each partner of said at least two partners; a lot number for said product being exchanged, said lot number being specific to said sending partner; at least one serial number corresponding to said product being exchanged; said at least one serial number being specific to said sending partner; clean-room, contamination, or cleanliness requirements for said receiving partner, said clean-room requirements consisting of compounds residing on surfaces of said product being exchanged; a product history, said product history consisting of a chronological list of processes having been performed on said product being exchanged, said processes having been performed by said sending partner; and a genealogy of said product being exchanged, said genealogy consisting of identification of each child product to said product being exchanged, a time and location when each said child product was created from said product being exchanged, identification of each parent product to said product being exchanged, and a time and location when said product being exchanged was produced from said parent product;

after said gathering, formatting said information for each said receiving partner, said formatting requirements for each said receiving partner being located in a shared archive and being accessible to said sending partner,

after said formatting, determining a transmission method for sending said formatted information to each said receiving partner, said determining requirements for each said receiving partner being located in said shared archive and being accessible to said sending partner, and

sending said formatted information to each said receiving partner in according to the transmission method associated with said receiving partner, respectively.

### BRIEF DESCRIPTION OF THE DRAWINGS

FIG. 1 illustrates a method for determining a single valuation for a product in order to facilitate export compliance and/or government audit, in accordance with embodiments of the present invention.

FIG. 2 illustrates a method for gathering and transmitting data necessary for exchanging product between at least two sites, where each site of the at least two sites being located in a different country, in accordance with embodiments of the present invention.

### DETAILED DESCRIPTION OF THE DRAWINGS

Although certain embodiments of the present invention are described herein, it is understood modifications may be made to the present invention without departing from its course and scope. Scope of the present invention is not limited to the number of constituting components, the materials thereof, the shapes thereof, the relative arrangement thereof, etc. Furthermore, while the accompanying drawings illustrate certain embodiments of the present invention, such drawings are not necessarily depicted to scale.

### Exportation Challenges

Since the search for partners transcends national boundaries, the frequent exchange of products across international boundaries creates the potential for export compliance errors. Penalties for under valuing exports can be severe leading to major fines and loss of export licenses while overvaluation can lead to excessive duty payments.

Products developed by multiple global partners pose particular problems for export compliance. First, valuation of development products may not be fixed as would be the case for products in regular production. Second, collaborative development could interrupt the production process at any point so exact valuation at the point of interruption may not be readily available. Third, the partners would likewise have to add value in partial production; and fourth, upon returning the product lot to the original partner, would have to account for the original partner's value plus their own.

Some companies utilize a single value for all their development products based on an average cost of the same. A weakness of this approach is that a single value is not sharable across multiple partners for global collaboration. First, it only applies to one partner's products and not their collaborators' products. Second, partners do not want to expose their proprietary cost detail with each other. Third, a single value offers no standard method or tool to produce consistent, repeatable, and verifiable results for government agency inspection. These challenges restrict the ability of collaborative development partners to exchange high priority product across international boundaries without potentially creating export value declaration issues.

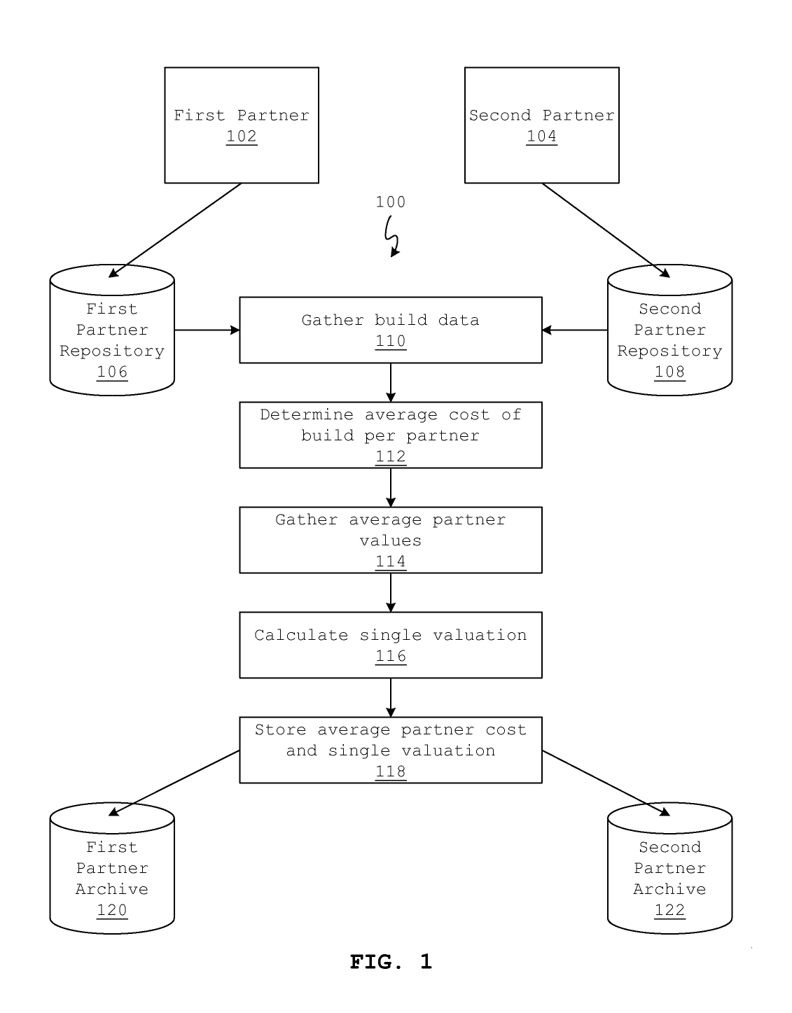

FIG. 1 illustrates a method 100 for determining a single valuation for a product in order to facilitate export compliance and/or government audit, in accordance with embodiments of the present invention.

The method 100 utilizes a first partner repository 106 and a second partner repository 108. The first partner repository 106 is a proprietary valuation space managed by a first partner 102. Likewise, the second partner repository is a proprietary valuation space managed by a second partner 104. The method 100 further utilizes a first partner archive 120 and a second partner archive 122. The first partner archive 120 and second partner archive 122 each retain the single valuation calculated by the method 100 for export compliance validation.

The method 100 begins with step 110 which gathers build data information from both the first partner repository 106 and the second partner repository 108. Note, FIG. 1 demonstrates step 110 utilizing only two partners; however embodiments of the present invention allows for a plurality of collaborating partners. The build data information which step 110 gathers relates to the operations and/or processes involved typically for full build, partial build, and short loop fabrication. Each partner (first partner 102 and second partner 104 in FIG. 1) may perform different and/or additional operations for a full build, partial build, or short loop; therefore it is critical to step 110 to determine each process associated with a partner's respective build scenario. Step 110 further gathers the cost for each partner associated with each process in a given build. Again, since different partners may have different costs, it is essential that step 110 gather all available information. After completion of step 110, the method 100 continues with step 112 which determines the average cost of the build per partner.

Step 112 calculates the average cost of the build per partner. Since each partner may utilize different processes and methods to produce the product, the average cost of the build is unique to a specific partner. For a given partner (e.g. the first partner 102) Step 112 determines the average cost based on the types of builds produces, the number of scenarios produced per build, the processes involved in said build scenarios, and the costs associated with said processes.

For example, say the first partner 102 produces one hundred full build scenarios, fifty partial build scenarios, and thirty short loop scenarios. Moreover, say the first partner's 102 full build contains processes A through I; the partial build contains processes A through F, and the short loop contains processes A, D, F. The first partner's 102 average cost of the build would be a function of the cost for each process (A through I) times the number of times said processes occurred in all builds (full, partial, and short loop). Step 112 repeats this process for all partners, creating a unique average cost of the build for each. After completion of step 112, the method 100 continues with step 114 which gathers the average partner values.

Step 114 gathers the average partner values. Some of the average partner values may have been calculated prior to the beginning of method 100; possibly on a previous instance of method 100. Therefore, step 114 gathers the newly determined average costs of the builds as well as the previously determined average costs of the builds per partner. After completion of step 114, the method 100 continues with step 116 which calculated the single valuation.

Step 116 calculates the single valuation as a function of the average cost of the build for all partners and the production quota for each partner. For example the first partner 102 has an average cost of $57,691.00 per build and expects to produce 624 scenarios. Moreover, the second partner 104 has an average cost of $251,337.00 per build and expects to produce 1980 scenarios. Step 116 calculates the single valuation as follows:

$$Single Valuation = \frac{\sum [ ( average \$ ) ( \# scenarios ) ]}{\sum ( \# scenarios )}$$

Therefore, according to the example data given step 116 would calculate the single valuation as $204,933.35. It is worth noting the single valuation is larger than the first partner's 102 average cost ($57,691.00) and smaller than the second partner's 104 average cost ($251,337.00). Thus, the first partner 102 will not be penalized for undervaluing the build for export and the second partner 104 will not overpay export tariffs. After completion of step 116, the method 100 continues with step 118 which stores the average partner cost and single valuation.

Step 118 stores the individual average partner cost and single valuation in the respective partner's archive. Additionally, step 118 stores all values necessary to demonstrate how the respective partner's average cost was calculated as well as how the single valuation was calculated. For example, step 118 would store in the first partner's archive 120 the first partner's 102 average cost, the single valuation, the first partner's 102 expected number of scenarios built, and the cost per processes in said scenarios. Step 118 would store similar information for the second partner 104 in the second partner archive 122.

It is of particular importance to point out that the archives are not accessible by their respective partners. While the partner may view the contents therein, they are unable to delete data stored in their archive. The secure nature of the archives ensure that when a customs agent and/or inspector wishes to investigate how the single valuation was calculated, they need not inquire as to whether the particular partner modified the valuation after step 116. After completion of step 118, the method 100 ends.

### Site Exchange Challenges

While the exchange of development product between collaborative partners is an effective process for correlating process and product technology, the process itself contains a number of hazards for the products and partners. The exchange of development product creates a series of heretofore awkward business processes executed outside of standardized production practices. Such non-standard practices cause delays, costly effort, and the potential for errors.

Advanced technology manufacturing sites are increasingly concerned with cleanliness, contamination, and other containment issues. Unfortunately, exchanging cleanliness and contamination information is not normal for a production site where all products are contained within a single domain. This information therefore is normally neglected in partner exchanges with potentially hazardous results.

When development product is exchanged in a collaborative development environment, the product can be exchanged at any point in the manufacturing process. This poses a challenge for the recipient partners since they must know exactly what has been completed with respect to the product so they know where to insert the product in their production line. Traditionally the dispatching partner mails such information to the recipient partner. This entails significant effort and a high potential for error. Information errors in turn increase the risk of mis-processing the product and ruining a valuable experiment.

In addition to knowing the product history, recent product and process measurements may be required for subsequent production operations at the recipient partner's site. Like the product history, measurement history is normally sent manually, the potential result being mis-information and mis-processing.

When collaborative development partners exchange information they must support a variety of data formats. For example, those who first see the product may be part of the Receiving team. Those who worry about cleanliness, contamination, and other containment issues would typically be the Containment team. Those who are concerned about where to start the product lot in the production line may be the development team. Each team is likely to need information in different formats or means of transmission, but for each team this information is vital to avoid mis-processing.

Additionally there is a need to trace product genealogy as product is split and merged as it is being processed. An original lot of product can be split into two child lots and remerged/merged with other lots of product. If a lot of product is split at one partner site and the child lots are sent to another partner site, the second partner site may not know, for analysis purposes, that the child lots are related to each other. The more times product lots are split and merged across multiple sites, the more difficult it is to get a consistent picture of history of the product lot. The collaborative partners therefore need to have a cumulative view of a product lot despite its fragmented processing history as a result of collaborative development.

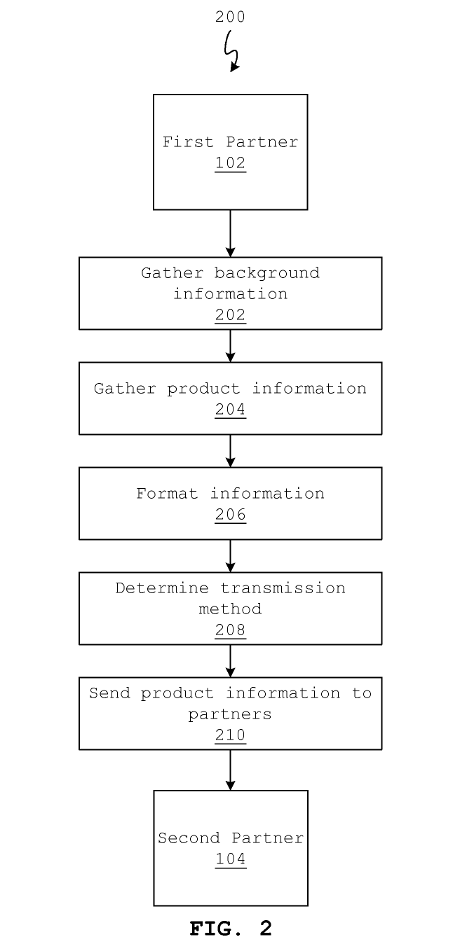

FIG. 2 illustrates a method 200 for gathering and transmitting data necessary for exchanging product between at least two sites, where each site of the at least two sites being located in a different country, in accordance with embodiments of the present invention.

The method 200 begins with step 202 which gathers background information on the product being exchanged. Step 202 gathers the background information from the first partner 102 who, in the example in FIG. 2, is the partner submitting the product to the second partner 104. The background information gathered by step 202 includes the identity, including location, of the partners in which to exchange the product. Additionally, step 202 identifies whether the product exchanged will return to the sender (the first partner 102 in FIG. 2) as well as the time and location of said return. After completion of step 202, the method 200 continues with step 204 which gathers product information.

Step 204 gathers product information from both the first partner repository 106 as well as the first partner archive 120. Step 204 gathers the single valuation calculated via method 100 from the first partner archive 120. Step 204 further gathers identifying information about the product being exchanged (e.g. lot number, size, serial numbers, etc.). Moreover, step 204 gathers clean-room details regarding the product being exchanged. The clean-room details may, for example, detail the chemical compounds residing on the surface of the exchanged product. Step 204 also collects the production history of the product, specifically what processes were applied and/or performed by the first partner 102 prior to the exchange. The production history would also include in what order said processes occurred. Finally, step 204 gathers the genealogy of the product being exchanged. The genealogy of a product includes details regarding the lineage of the current product, the siblings of the product being exchanged, as well as the descendents of the product. The information regarding the genealogy may include where the current product has been, when it split from its parents, if it was rejoined with said parents, when and where its siblings were separated, what processes said siblings received, etc. After completion of step 204, the method 200 continues with step 206 which formats the information.

Step 206 formats the information according to the requirements of the receiving partners. In the example in FIG. 2, the first partner 102 would format the information gathered in steps 202 and 204 according to the requirements of the second partner 104. Ideally, the format requirements for the receiving partners (the second partner 104 in FIG. 2) would be stored in a shared archive so the sending partner could easily obtain said requirements. After completion of step 206, the method 200 continues with step 208 which determines the transmission method.

Step 208 determines the transmission method according to the requirements of the receiving partners. Each receiving partner may require the transmission of data gathered in steps 202 and 204 differently (e.g. via email, facsimile, certified mail, etc.). Again, in an ideal environment, the desired transmission method would be stored in the shared archive so the sending partner can easily obtain the information. After determining the method for transmission 208, the method 200 sends the product information to the partners 210.

Step 210 sends the product information gathered in step 202 and 204 to the identified receiving partners in the desired format determined in step 206 and via the transmission method identified in step 208. After completion of step 210, the method 200 ends.

What is claimed:

1. A method for gathering data necessary for exchanging a product between at least two partners, wherein one partner in said at least two partners is a sending partner, wherein each partner in said at least two partners which is not said sending partner is a receiving partner, wherein said sending partner and each receiving partner is a different partner, wherein each partner in said at least two partners resides in a different country, said method comprising:
gathering information regarding said product being exchanged, said information consisting of:
a delivery location for each receiving partner;
a flag indicating that said product is returning to said sending partner;
a returning date and returning location;
a single valuation for said product being exchanged, said single valuation being a function of a weighted average cost for each partner of said at least two partners, said weighted average cost computed using a weight consisting of a scenario number for each partner of said at least two partners;
a lot number for said product being exchanged, said lot number being specific to said sending partner;
at least one serial number corresponding to said product being exchanged; said at least one serial number being specific to said sending partner;
clean-room, contamination, or cleanliness requirements for said receiving partner, said clean-room requirements consisting of compounds residing on surfaces of said product being exchanged;
a product history, said product history consisting of a chronological list of processes having been performed on said product being exchanged, said processes having been performed by said sending partner; and
a genealogy of said product being exchanged, said genealogy consisting of identification of each child product to said product being exchanged, a time and location when each said child product was created from said product being exchanged, identification of each parent product to said product being exchanged, and a time and location when said product being exchanged was produced from said parent product;
after said gathering, formatting said information for each said receiving partner, said formatting requirements for each said receiving partner being located in a shared archive and being accessible to said sending partner;
after said formatting, determining a transmission method for sending said formatted information to each said receiving partner, said determining requirements for each said receiving partner being located in said shared archive and being accessible to said sending partner, and
sending said formatted information to each said receiving partner in according to the transmission method associated with said receiving partner, respectively.

2. The method of claim 1, wherein said single valuation is a function being calculated according to
$$Single Value = \frac{{\sum }_{n = 1}^{N} {A}_{n} * {S}_{n}}{{\sum }_{n = 1}^{N} {S}_{n}} ,$$
wherein Aₙ is said weighted average cost for partnerₙ to produce said product to be exchanged, wherein Sₙ is said scenario number for partnerₙ and being equal to a number of said product to be exchanged which partnerₙ expects to produce, wherein N is the total number of partners in said at least two partners, wherein n is an index of said at least two partners for n=1, 2, . . . , N.
